(19) United States
(12) Patent Application Publication
(10) Pub. No.: US 2012/0197955 A1
(43) Pub. Date: Aug. 2, 2012

(54) METHOD, APPARATUS, AND COMPUTER PROGRAM PRODUCT FOR RESOURCE, TIME, AND COST AWARE VARIABLE-PRECISION SOLVING OF MATHEMATICAL FUNCTIONS

(75) Inventors: Claudio Brunelli, Tampere (FI); Heikki Berg, Seinajoki (FI); David Guevorkian, Tampere (FI)

(73) Assignee: Nokia Corporation, Espoo (FI)

(21) Appl. No.: 13/018,049

(22) Filed: Jan. 31, 2011

(51) Int. Cl. G06F 17/11

(52) U.S. Cl. 708/446

(57) ABSTRACT

An apparatus for solving a function, such as a mathematical function, may be configured to minimize cost indicators associated with solving the function. Embodiments may be used to compute, in a fast and efficient way, the results of a given mathematical function f(x) and to execute the required operations on the best possible computational elements available within the target platform. Embodiments may exploit a mixture of calculation/evaluation methods that can be implemented on each computational element of the platform in order to approximate the desired function within the desired degree of accuracy and at a low computational cost. Associated methods and computer program products may also be provided.

### TECHNICAL FIELD

Embodiments of the present invention relate generally to computational analysis, and, more particularly, relate to a method, apparatus, and a computer program product for identifying a process for calculating mathematical functions.

### BACKGROUND

The employment of computing devices, such as processors, e.g., microprocessors, to calculate solutions to mathematical functions has sometimes been problematic due to their digital nature. Computing devices are typically capable of solving many mathematical functions, or at least approximating a solution, but the process of reaching the solution can sometimes be computationally intensive for the computing device and therefore costly, in terms of numbers of computations, time, and power consumption.

Since the computer age has introduced computing devices to substantially all aspect of our lives, the use of computing devices to solve mathematical functions, particularly computationally complex mathematical functions, is becoming increasingly common. For example, computing devices are frequently employed in the fields of applied mathematics, computational science, electronics, and telecommunications to calculate solutions to mathematical functions and apply the results. In these fields, it is often necessary to calculate several different kinds of mathematical functions, ranging from the elementary ones, to trigonometric and transcendental functions.

Particularly for telecommunications and electronics applications, techniques currently exist that are aimed at calculating functions within a certain accuracy using approximations. Examples of these include techniques such as the Coordination Rotation Digital Computer (CORDIC) method, Briggs' method for logarithms, Newton's method, Taylor series expansion, Spline interpolation, linear interpolation, Padé rational approximation, and the Chebychev approximation. These techniques provide means for computing devices to calculate many functions in terms of elementary operations such as multiplications, additions, and divisions. However, use of these techniques does not guarantee that the solutions for the mathematic functions fall within a desired precision margin. Further, use of a conventional technique may not result in a minimum cost for the computing device to determine the solution.

### BRIEF SUMMARY

A method, apparatus, and computer program product are described that identify techniques for solving functions, such as mathematical functions. In this regard, embodiments of the present invention can be used to compute, in a fast and efficient way, the results of a given mathematical function f(x) and to execute the required operations on the best possible computational elements available in the target platform. Methods according to example embodiments of the present invention exploit a mixture of calculation/evaluation methods that can be implemented on each computational element of the platform in order to approximate the desired function within the desired degree of accuracy and at a low computational cost. The computational cost is a cost function that includes the cost associated with solving a function executing an approximation method (e.g., CORDIC method, Briggs' method for logarithms, Newton's method, Taylor series expansion, Spline interpolation, linear interpolation, Padé rational approximation, Chebychev approximation, or the like) on a computational element (e.g., a processor). The cost function may indicate the efficiency of using different approximation methods to solve the function on different computational elements. Efficiency may be determined with respect to the number of computations, time, power usage, memory usage, or the like needed to determine a solution to the function. In some embodiments, a cost function may describe the cost with respect to a specific domain interval of the function. In this regard, the domain of the function may be separated into domain intervals and cost indicators may be determined for each candidate technique with respect to each domain interval. Also, in some example embodiments, the approximation methods may be eliminated if the maximum error of the technique for the value of variables in the domain interval exceeds a threshold error. Further, approximation methods may be selected based on the cost function. For example, the approximation methods may be selected that have a minimum cost value as indicated by the cost function. The selected approximation methods may be used to configure an application processor. In this regard, the application processor may be configured to solve the function using the selected techniques when deployed in the field or used by consumers.

Accordingly, in one example embodiment, a method for solving a function may include identifying approximation methods for solving a function, identifying computational elements for solving the function, and mapping a respective approximation method with each identified computational element to create a mapped pair. The method may further include determining a cost indicator for each mapped pair and selecting a mapped pair based on the cost indicators. The method may then direct the function to be solved using the approximation method and the computational element of the selected mapped pair. Optionally, the method may include providing for configuring the computational element of the selected mapped pair to solve the function via the approximation method of the selected mapped pair. The function may be solved over a domain that includes at least two domain intervals, where identifying approximation methods for solving the function includes identifying approximation methods for solving the function over each of the at least two domain intervals, and where identifying computational elements for solving the function includes identifying computational elements for solving the function over each of the at least two domain intervals. Selecting a mapped pair based on the cost indicators may include selecting a mapped pair for each of the at least two domain intervals based on the cost indicators of each mapped pair. Directing the function to be solved may include directing the function to be solved over each of the at least two domain intervals using the approximation method and the computational element of the selected mapped pair for each respective domain interval. Directing the function to be solved over each of the at least two domain intervals may include identifying the domain interval to which a current input to the function belongs and directing the function to be solved for the current input using the approximation method and the computational element of the selected mapped pair for the identified domain interval. The selected mapped pair for each of the at least two domain intervals may include the same approximation method but having different accuracy levels, the accuracy levels being associated with approximation methods employing approximations using polynomials of different orders. Identifying approximation methods for solving the function may include identifying approximation methods for solving the function based on a maximum error threshold. Determining the cost indicator for each mapped pair may include determining the cost indicator based on a number of arithmetic computations needed for solving the function using the approximation method of the mapped pair. Determining the cost indicator for each mapped pair may include determining the cost indicator based on the computational element of the mapped pair.

In another example embodiment, an apparatus for selecting approximation methods and computational elements for solving a function is described. The apparatus may include a processor and at least one memory including computer program code. The at least one memory and the computer program code may be configured to, with the at least one processor, cause the apparatus to identify approximation methods for solving a function, identify computational elements for solving the function, and map a respective approximation method with each identified computational element to create a mapped pair. The apparatus may further be caused to determine a cost indicator for each mapped pair and select a mapped pair based on the cost indicators. The apparatus may be caused to direct the function to be solved using the approximation method and the computational element of the mapped pair. Optionally, the apparatus may be configured to provide for configuring the computational element of the selected mapped pair to solve the function via the approximation method of the selected mapped pair. The identified function may be solved over a domain that includes at least two domain intervals, where the apparatus may further be caused to identify approximation methods for solving the function by identifying approximation methods for solving the function over each of the at least two domain intervals, and where the apparatus may be further caused to identify computational elements for solving the function by identifying computational elements for solving the function over each of the at least two domain intervals. Selecting a mapped pair based on the cost indicators may include selecting a mapped pair for each of the at least two domain intervals based on the cost indicators of each mapped pair. Causing the apparatus to direct the function to be solved may include causing the apparatus to direct the function to be solved over each of the at least two domain intervals using the approximation method and the computational element of the selected mapped pair for each respective domain interval. Causing the apparatus to direct the function to be solved over each of the at least two domain intervals may include causing the apparatus to identify the domain interval to which a current input to the function belongs and causing the apparatus to direct the function to be solved for the current input using the approximation method and the computational element of the selected mapped pair for the identified domain interval. The selected mapped pairs for each of the at least two domain intervals may include the same approximation method, but having different accuracy levels, where the accuracy levels are associated with approximation methods employing approximations using polynomials of different orders. Identifying approximation methods for solving the function may include identifying approximation methods for solving the function based on a maximum error threshold. Determining the cost indicator for each mapped pair may include determining the cost indicator based on a number of arithmetic computations needed for solving the function using the approximation method of the mapped pair. Determining the cost indicator for each mapped pair may include determining the cost indicator based on the computational element of the mapped pair.

In another example embodiment, a computer program product for selecting approximation methods and computational elements for solving a function is described. The computer program product may include at least one computer-readable storage medium having computer-executable program code instructions stored therein. The computer-executable program code instructions including program code instructions identifying approximation methods for solving a function, program code instructions for identifying computational elements for solving the function, and program code instructions for mapping a respective approximation method with each identified computational element to create a mapped pair. The computer-executable program code may further include program code instructions for determining a cost indicator for each mapped pair and program code instructions for selecting a mapped pair based on the cost indicators. The computer program product may further include program code instructions for directing the function to be solved using the approximation method and the computational element of the selected mapped pair. Optionally, the computer program product may include program code instructions for providing for configuring the computational element of the selected mapped pair to solve the function via the approximation method of the selected mapped pair. The function may be solved over a domain that includes at least two domain intervals, where the program code instructions for identifying approximation methods for solving the function may include program code instructions for identifying approximation methods for solving the function over each of the at least two domain intervals, and where the program code instructions for identifying computational elements for solving the function may include program code instructions for identifying computational elements for solving the function over each of the at least two domain intervals. The program code instructions for selecting a mapped pair based on the cost indicators may include program code instructions for selecting a mapped pair for each of the at least two domain intervals based on the cost indicators for each mapped pair. The program code instructions for directing the function to be solved may include program code instructions for directing the function to be solved over each of the at least two domain intervals using the approximation method and the computational element of the selected mapped pair for each respective domain interval. The program code instructions for directing the function to be solved over each of the at least two domain intervals may include program code instructions for identifying the domain interval to which a current input to the function belongs and program code instructions for directing the function to be solved for the current input using the approximation method and the computational element of the selected mapped pair for the identified domain interval. The selected mapped pairs for each of the at least two domain intervals may include the same approximation method, but having different accuracy levels, the accuracy levels being associated with approximation methods employing approximations using polynomials of different orders. The program code instructions for identifying approximation methods for solving the function may include program code instructions for identifying approximation methods for solving the function based on a maximum error threshold. The program code instructions for determining the cost indicator for each mapped pair may include program code instructions for determining the cost indicator based on a number of arithmetic computations needed for solving the function using the approximation method of the mapped pair.

In yet another example embodiment, an apparatus for selecting approximation methods and computational elements for solving a function is described. The apparatus may include means for identifying approximation methods for solving a function, means for identifying computational elements for solving the function, and means for mapping a respective approximation method with each identified computational element to create a mapped pair. The apparatus may include means for determining a cost indicator for each mapped pair and means for selecting a mapped pair based on the cost indicators. The apparatus may include means to direct the function to be solved using the approximation method and the computational element of the mapped pair. Optionally, the apparatus may include means for providing for configuring the computational element of the selected mapped pair to solve the function via the approximation method of the selected mapped pair. The identified function may be solved over a domain that includes at least two domain intervals, where the means for identifying approximation methods for solving the function may include means for identifying approximation methods for solving the function over each of the at least two domain intervals, and where the means for identifying computational elements for solving the function may include means for identifying computational elements for solving the function over each of the at least two domain intervals. The means for selecting a mapped pair based on the cost indicators may include means for selecting a mapped pair for each of the at least two domain intervals based on the cost indicators of each mapped pair. The means for directing the function to be solved may include means for directing the function to be solved over each of the at least two domain intervals using the approximation method and the computational element of the selected mapped pair for each respective domain interval. The means for directing the function to be solved over each of the at least two domain intervals may include means for identifying the domain interval to which a current input to the function belongs and means for directing the function to be solved for the current input using the approximation method and the computational element of the selected mapped pair for the identified domain interval. The selected mapped pairs for each of the at least two domain intervals may include the same approximation method, but having different accuracy levels, where the accuracy levels are associated with approximation methods employing approximations using polynomials of different orders. The means for identifying approximation methods for solving the function may include means for identifying approximation methods for solving the function based on a maximum error threshold. The means for determining the cost indicator for each mapped pair may include means for determining the cost indicator based on a number of arithmetic computations needed for solving the function using the approximation method of the mapped pair. The means for determining the cost indicator for each mapped pair may include means for determining the cost indicator based on the computational element of the mapped pair.

Various other methods, apparatuses, and computer program products are also provided for identifying techniques for solving functions. For example, another apparatus may include a processor, and the processor may be configured to solve a function with an input, wherein the function is solved via a selected approximation method and computational element associated with a domain interval indicated by the input. The selected approximation method may have been selected by identifying approximation methods, separating a domain of the function into a plurality of domain intervals including the domain interval indicated by the input, determining a cost indicator for each approximation methods as applied to the domain interval indicated by the input, and selecting a approximation methods for the domain interval indicated by the input based on the cost indicators.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an apparatus for identifying techniques for solving functions according to various example embodiments of the present invention;

FIG. 2 is a schematic block diagram of an apparatus configured to solve a function via a selected technique according to various example embodiments of the present invention;

FIG. 3 is a flowchart of a method for identifying techniques for solving functions according to various example embodiments of the present invention;

FIG. 4 is a flowchart of a method for solving functions according to various example embodiments of the present invention; and

FIG. 5 is a flowchart of a method of solving a function via a selected technique according to various example embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. Moreover, the term “exemplary,” as used herein, is not provided to convey any qualitative assessment, but instead to merely convey an illustration of an example.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Computing devices are typically capable of solving many mathematical functions or approximating a solution. As functions increase in complexity, the computational requirements to solve the function increase, as does time and cost. In an attempt to reduce both the time and the cost, approximating a solution may be possible to reduce the computational requirements for solving the function. However, approximating a solution may also reduce the accuracy of the solution.

Example embodiments of the present invention may be implemented to reduce the computational requirements and cost involved in solving mathematical functions. Disclosed herein is a method, apparatus, and computer program product configured to optimize approximation methods and computational elements to reduce the cost required in solving mathematical formulas.

Example embodiments disclosed herein may be configured to find a convenient way of calculating the result of mathematical functions using a digital computer system by identifying the best method among a set of numerical approximation methods mapped to a set of computational elements, and identifying the best method of mapping the numerical approximation methods to the computational elements. In general, it may not always be possible or convenient to rely upon dedicated circuits (e.g., ASICS) which can compute the results of such functions in hardware. For this reason, to compute a function on a digital computer it may be desirable to find a way of expressing the function in terms of elementary arithmetic operations (such as addition and multiplication) which can be commonly solved with minimal computational requirements of a digital computer. The more complex the mathematical formulation for solving the expression, the slower the execution of the computational element, the higher the cost and power consumption. Conversely, the simpler the mathematical formulation for solving the expression, the greater the possibility of a larger error introduced by the approximation.

As there are several contradicting criteria in the optimization of approximation methods for solving mathematical functions, to simplify the optimization the criteria can be combined into a single cost function that can be solved for a cost indicator. Both the accuracy and the complexity of the approximation methods depend significantly on the computational element to which the approximation method is mapped (e.g., where the method is to be implemented). Each computational element may have specific characteristics (e.g., in terms of processing speed, power consumption, throughput, etc.) that can be summarized into a figure of merit. The general problem of determining the most suitable solution for calculating a given mathematical function on a given hardware platform may be reformulated as finding the best pair (approximation method×computational element) to minimize a cost function over all possible pairs that could be used to solve that mathematical function.

It is noted that the approximation method described above indicates the exact order of operations that need to be implemented. The same method (e.g., the Taylor approximation method) used with different parameters (e.g., with different degrees of polynomials used) should be considered as separate approximation methods. It is also noted that conventional computational platforms often involve reconfigurable computational elements (processing elements) with different configurations resulting in different computational complexity figures. For simplicity of the present disclosure, different configurations of a computational element will be considered different computational elements.

Example embodiments of the present invention may determine the most optimal pair (approximation method×computational element) in consideration of the input to the function. That is, in determining the optimum pair according to a given cost function for calculating the value of a mathematical function, the input arguments of the function may be considered.

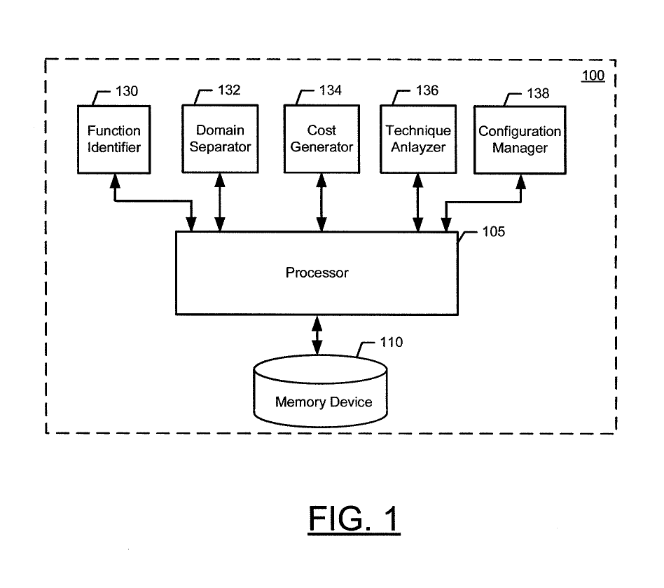

FIG. 1 illustrates an exemplary apparatus 100 that may provide means for identifying techniques for solving functions. According to various exemplary embodiments of the present invention, the apparatus 100 may be embodied as, or included as a component of, a computing device such as any type of wired or wireless computing device including, for example, a computer, a server, a computer system or the like. Further, the apparatus 100 may be configured to implement various aspects of the present invention as described herein including, for example, various exemplary methods of the present invention, where the methods may be implemented by means of hardware or software configured processor, computer-readable medium, or the like.

The apparatus 100 may, in some embodiments, be a mobile terminal or a fixed communication device or computing device configured to employ an example embodiment of the present invention. However, in some embodiments, the apparatus 100 may be embodied as a chip or chip set. In other words, the apparatus 100 may comprise one or more physical packages, e.g., chips, including materials, components and/or wires on a structural assembly, e.g., a baseboard. The structural assembly may provide physical strength, conservation of size and/or limitation of electrical interaction for component circuitry included thereon. The apparatus 100 may therefore, in some cases, be configured to implement an embodiment of the present invention on a single chip or as a single “system on a chip”. As such, in some cases, a chip or chipset may constitute means for performing one or more operations for providing the functionalities described herein.

The apparatus 100 may include or otherwise be in communication with a processor 105, and a memory device 110. In some embodiments, the apparatus 100 may also include a communications interface for connectivity to a network, a user interface to interface with a user of the apparatus 100, and/or an output device that may be configured to allow data, such as application processor configuration data, to be copied onto a removable media, such as, a memory card, a compact disc, a digital versatile disc, a floppy disk, or the like. The processor 105 may be embodied as various means including, for example, a microprocessor, a coprocessor, a controller, processing circuitry, or various other processing devices including integrated circuits such as, for example, an ASIC (application specific integrated circuit), an FPGA (field programmable gate array), or a hardware accelerator. In an example embodiment, the processor 105 may be configured to execute instructions stored in the memory device 110 or instructions otherwise accessible to the processor 105. Processor 105 may also be configured to facilitate communications via the communications interface by, for example, controlling hardware and/or software included in the communications interface.

The memory device 110 may be a computer-readable storage medium that may include volatile and/or non-volatile memory. For example, memory device 110 may include Random Access Memory (RAM) including dynamic and/or static RAM, on-chip or off-chip cache memory, and/or the like. Further, memory device 110 may include non-volatile memory, which may be embedded and/or removable, and may include, for example, read-only memory, tangible, non-transitory memory, flash memory, magnetic storage devices (e.g., hard disks, floppy disk drives, magnetic tape, etc.), optical disc drives and/or media, non-volatile random access memory (NVRAM), and/or the like. Memory device 110 may include a cache area for temporary storage of data. In this regard, some or all of memory device 110 may be included within the processor 105.

Further, the memory device 110 may be configured to store information, data, applications, computer-readable program code instructions, or the like for enabling the processor 105 and the apparatus 100 to carry out various functions in accordance with example embodiments of the present invention. For example, the memory device 110 could be configured to buffer input data for processing by the processor 105. Additionally, or alternatively, the memory device 110 may be configured to store instructions for execution by the processor 105.

The function identifier 130, domain separator 132, cost generator 134, technique analyzer 136, and configuration manager 138 of apparatus 100 may be any means or device embodied in hardware (e.g., circuitry), a computer program product, or a combination of hardware and software, such as processor 105 implementing computer program product instructions or a hardware configured processor 105, that is configured to carry out the functions of function identifier 130, domain separator 132, cost generator 134, technique analyzer 136, and/or configuration manager 138 as described herein. In an example embodiment, the processor 105 may include, or otherwise control function identifier 130, domain separator 132, cost generator 134, technique analyzer 136, and/or configuration manager 138. In various exemplary embodiments, function identifier 130, domain separator 132, cost generator 134, technique analyzer 136, and/or configuration manager 138 may reside on differing apparatuses such that some or all of the functionality of the function identifier 130, domain separator 132, cost generator 134, technique analyzer 136, and/or configuration manager 138 may be performed by a first apparatus, and the remainder of the functionality of the function identifier 130, domain separator 132, cost generator 134, technique analyzer 136, and/or configuration manager 138 may be performed by one or more other apparatuses.

The function identifier 130 may be configured to identify a function. The function may be a mathematical function, such as a linear function, an exponential function, a transcendental function, a trigonometric function, an algebraic function, a differential function, combinations thereof, or the like. The function may include any number of variables and may be calculated over a domain for each of the variables or a generalized domain for all variables. Examples of functions may be f(x)=sin x, f(x)=ax²+bx+c, or the like. In some embodiments, the function may be defined by an application that may apply the results of the function. For example, in a communications application, the identified function may be for an estimated frequency error for subframes of an orthogonal frequency division multiplexing (OFDM) communications system.

In some example embodiments, identifying the function may include receiving the function via the communications interface from, for example, another network device, or via the user interface from a user. In some example embodiments, identifying the function may include retrieving the function from a memory device, such as memory device 110. In some example embodiments, the function may be identified from an application being executed by processor 105.

Means may be provided to identify approximation methods. For example, the function identifier 130 may also be configured to identify approximation methods for solving the function. In this regard, the approximation methods may be interpolation and/or approximation methods for solving a function. For example, the approximation methods may include the CORDIC method, the Briggs' method for logarithms, the Newton's method, the Taylor series expansion, the Spline interpolation, the linear interpolation, the Padé rational approximation, the Chebychev approximation, or the like. Use of the approximation methods to solve a function may result in using elementary operations (e.g., addition, multiplication, division, etc.) to determine or approximate the solution of the function on a processing device.

The function identifier 130 may also be configured to identify approximation methods where the approximation methods may be of a same technique type, but have different accuracy levels. Further, the accuracy levels may be associated with approximation methods employing approximations using polynomials of different orders. In this regard, for example, a Taylor polynomial of differing orders may be considered separate candidate techniques. Moreover, the same technique type (e.g., Taylor polynomial) may be utilized as different candidate techniques, where each candidate technique in this regard is directed to a different level of accuracy.

In some exemplary embodiments, identifying the approximation method for solving the function may include receiving the approximation methods via the communications interface from, for example, another network device, or via the user interface from a user. In some example embodiments, identifying the approximation methods may include retrieving the approximation methods from a memory device, such as memory device 110. In some example embodiments, the approximation methods may be identified from an application being executed by processor 105.

Further, the function identifier 130 may be configured to receive a maximum error for solutions of the function. In this regard, the maximum error may define the accuracy of a result of a function for each candidate technique. In one example embodiment where the variable values and output values of the function are 16-bit fixed point integer representations, an example maximum error may be 1/(2̂15). Approximation methods may also have associated methods for determining or calculating the accuracy of the approximation methods. In this regard, the maximum error may be calculated using the associated methods and the apparatus 100 may be configured to do so. The maximum error may be received via the communications interface from, for example, another network device, or via the user interface from a user.

The domain separator 132 may be configured to separate a domain of the function into a plurality of domain intervals. In this regard, the domain, which may also be referred to as a variable range, may be the range of values for a variable of the function. For example, a variable of the function may have a domain of negative infinity to positive infinity, zero to one, negative π to positive π, or the like. In example embodiments where the function includes multiple variables, a domain may be identified for each variable for the function or a generalized domain may be identified.

In an example embodiment, splitting the domain into a number of intervals may be performed such that the intervals are of equal or unequal length. For example, if a domain is zero to five, the equally sized domain intervals may be zero to one, one to two, two to three, three to four, and four to five. Further, in some example embodiments, the domain of zero to five may be separated into unequal domain intervals zero to one, two to four, and four to five. In another example embodiment, the domain may be split such that the borders of intervals are chosen so that they are each powers of two (e.g., two to four, four to eight, eight to sixteen, etc.). In this manner, given a value expressed, for instances, in a binary integer fixed point format, the operation of retrieving the interval to which the value belongs is immediate: it is enough to perform a shift left of the value by a sufficient number of positions, and the value obtained represents the encoding of the interval number. Further example embodiments may allow a “variable precision” approach within each approximation method. For example, allowing Taylor polynomials to be developed to different orders on different intervals of the domain.

The cost generator 134 may be configured to determine respective cost indicators for each approximation method as applied to each domain interval of the function. In some exemplary embodiments, the memory device 110 may be configured to store the cost indicators for selection of the selected approximation methods. The cost indicators may be indicative of a computation cost of utilizing a particular approximation method and a computational element for a respective domain interval. In this regard, each approximation method may be analyzed with respect to each computational element and each domain interval to determine the cost indicators using a cost function. Analyzing the approximation method with respect to a computational element and a domain interval may involve solving the function using a value for the variable that is within the domain interval. In some example embodiments, analyzing the approximation methods may involve solving the function twice, where the variables used to solve the function are near or at the extents of the domain interval.

The cost indicators may be determined based on a variety of criteria and conditions. In some exemplary embodiments, the cost indicators may be determined based on the number of elementary arithmetic operations (e.g., addition, multiplication, division, etc.) required to solve the function using an approximation method and a computational element. In some example embodiments, the cost generator 134 may be configured to determine the respective cost indicators based on respective times or respective power consumption for solving the function using each approximation method as applied to each computational element and each domain interval of the function. In this regard, the cost generator may implement a timer to determine how long each candidate technique takes to determine a solution for the function. Additionally, or alternatively, the cost generator 134 may be configured to determine the respective cost indicators based on respective memory usage for solving the function using each candidate technique as applied to each domain interval of the function. In this regard, the number of memory location accesses may be counted while solving the function using the candidate techniques. Further, the maximum quantity of memory used to solve the function using the candidate techniques may be considered in the cost indicators.

Additionally, or alternatively, the cost generator 134 may be configured to determine the respective cost indicators based on a platform architecture including an application processor. In this regard, the platform architecture may be representative of a device, such as a mass produced device, that will be configured to implement selected techniques when the devices are deployed in the field or used by consumers. The platform architecture may include the computing architecture of the device or the layout of computational components within the device such as, for example, the layout of the processors, memory devices, and the like. For example, the platform architecture may be that of a cellular phone, or another mobile terminal. In some example embodiments, the platform architecture of a device may be emulated and cost indicator criteria may be determined based on solving the functions using the approximation methods on the emulated platform. In some example embodiments, the approximation methods may be mapped to the platform to generate the platform architecture. The cost indicators may then be determined based on the operation of the platform architecture. In this manner, the cost indicators may be determined in consideration of the efficiency of the overall platform architecture.

The technique analyzer 136 may be configured to select a technique for each domain interval based on the cost indicators. In this regard, each domain interval may have a cost indicator for each approximation method and computational element. The cost indicators may be analyzed on a domain interval-by-domain interval basis to select approximation methods for each domain interval. In some example embodiments, an approximation method may be selected for a domain interval because the method is associated with a cost indicator having the minimum cost for the respective domain interval. The cost indicators may also be configured based on the criteria to describe, for example, the selections that result in a minimum amount of arithmetic calculations with larger memory usage, minimum memory usage with a larger number of arithmetic calculations, or the like.

In some example embodiments, the selection of approximation methods may be based on the maximum error or a maximum error threshold. Approximation methods that provide results outside of the maximum error threshold may be eliminated from selection. Further, approximation methods that are of the same type but having different accuracy levels may provide for solutions that are within the maximum error and have a minimum cost indicator value. Also, in some example embodiments, selection of the selected approximation methods may be facilitated by user input via, for example, the user interface to assist in selecting a mix of approximation methods.

The selected approximation methods may comprise a mixture of methods for solving the function over the entire domain. When applied, inputs to the function may determine the domain interval and the associated selected approximation method for the domain interval. The selected method for that domain interval may then be used to solve the function.

The configuration manager 138 may be configured to provide for configuring a computational element to solve the function via the selected approximation method and the respective domain intervals. In this regard, the configuration manager 138 may facilitate configuring an computational element on a device, or a plurality of computational elements on plurality of devices, to enable the devices to solve the function using the selected approximation methods when a solution to the function is needed. In some example embodiments, the configuration manager 138 may configure the computational elements by being an input to a manufacturing process for the computational elements that are hardware or software configured. In example embodiments where the computational elements are software configured, the configuration manager may facilitate configuring a memory device associated with the computational elements to thereby configure the application processors.

To communicate the selected approximation methods to the computational elements, the configuration manager may output the selected methods via the communications interface or via the output device or a removable memory device. In some example embodiments, the communications interface of apparatus 100 may use a wired or wireless communications link to update software in a memory device associated with the application processors.

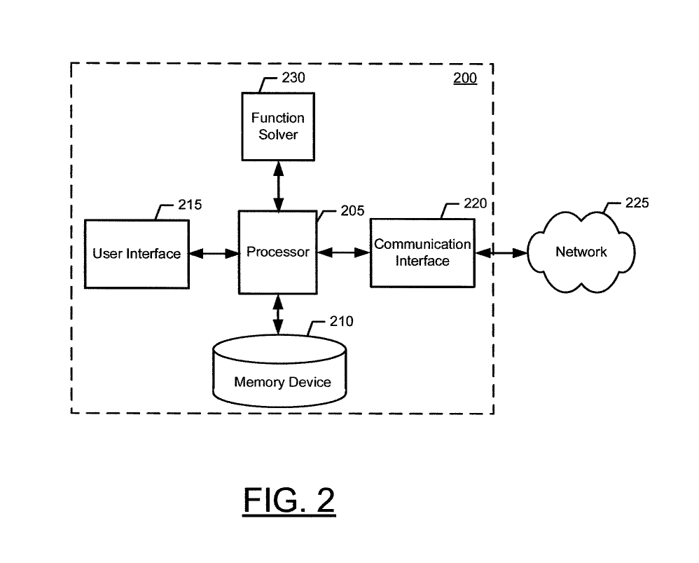

FIG. 2 illustrates a schematic block diagram of an apparatus 200 configured to solve a function via selected approximation methods according to various example embodiments of the present invention. In some example embodiments, the apparatus 200 may be embodied as, or included as a component of, a computing device which may or may not have wired or wireless communications capabilities. Some examples of the apparatus 200 may include a computer, a server, a calculator, a mobile terminal such as, a mobile telephone, a portable digital assistant (PDA), a pager, a mobile television, a gaming device, a mobile computer, a laptop computer, a camera, a video recorder, an audio/video player, a radio, and/or a global positioning system (GPS) device, a network entity such as an access point such as a base station, or any combination of the aforementioned, or the like. Further, the apparatus 200 may be configured to implement various aspects of the present invention as described herein including, for example, various example methods of the present invention, where the methods may be implemented by means of a hardware or software configured processor, computer-readable medium, or the like.

The apparatus 200 may include or otherwise be in communication with a processor 205, a memory device 210, a user interface 215, and a communication interface 220. In some embodiments, the apparatus 200 need not include the user interface 215 and/or the communication interface 220. The processor 205 may be embodied as various means including, for example, a microprocessor, a coprocessor, a controller, processing circuitry, or various other processing devices including integrated circuits such as, for example, an ASIC (application specific integrated circuit), an FPGA (field programmable gate array), or a hardware accelerator. In an example embodiment, the processor 205 may be configured to execute instructions stored in the memory device 210 or instructions otherwise accessible to the processor 205. Processor 205 may also be configured to facilitate communications via the communications interface 220 by, for example, controlling hardware and/or software included in the communications interface 220.

The memory device 210 may be a computer-readable storage medium that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, tangible, non-transitory memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the apparatus 200 to carry out various functions in accordance with example embodiments of the present invention. For example, the memory device 210 could be configured to buffer input data for processing by the processor 205. Additionally, or alternatively, the memory device 210 may be configured to store instructions for execution by the processor 205.

The communication interface 220 may be any device or means embodied in either hardware, a computer program product, or a combination of hardware and a computer program product that is configured to receive and/or transmit data from/to a network and/or any other device or module in communication with the apparatus 200. In this regard, the communication interface 220 may include, for example, an antenna, a transmitter, a receiver, a transceiver and/or supporting hardware, including a processor or software for enabling communications with network 225. Via the communication interface 220 and the network 225, the apparatus 200 may communicate with various other network entities.

The communications interface 220 may be configured to provide for communications in accordance with any wired or wireless communication standard. For example, communications interface 220 may be configured to provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 220 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

The function solver 230 of apparatus 200 may be any means or device embodied in hardware, a computer program product, or a combination of hardware and a computer program product, such as processor 205 implementing software instructions or a hardware configured processor 205, that is configured to carry out the functions of the function solver 230 as described herein. In an example embodiment, the processor 205 may include, or otherwise control the function solver 230. In various example embodiments, the function solver 230 may reside on differing apparatuses such that some or all of the functionality of the function solver 230 may be performed by a first apparatus, and the remainder of the functionality of the function solver 230 may be performed by one or more other apparatuses.

The function solver 203 may be configured to solve a function with the selected methods that have been selected as described above, and the function solver 230 may be an example embodiment of an application processor. In this regard, the function solver may be configured to solve a function with an input. The input may be one or more values for the variables of the function. The input may be provided via the user interface 215, the communication interface 220, or some other entity that may be controlled by, or otherwise interact with the processor 205.

The function solver 230 may be configured to solve the function via the selected approximation methods associated with a domain interval indicated by the input. In this regard, the input may be one or more values for the one or more variables of the function within a domain interval, and through the input values the domain interval may be identified. Accordingly, the selected approximation method may be identified based on the domain interval. The function may then be solved using the variable values and the selected technique.

In various embodiments, the selected approximation method may have been received by the apparatus 200 via the apparatus 100 as described above. In some example embodiments, the selected technique may be determined by identifying candidate techniques and separating a domain of the function into a plurality of domain intervals including the domain interval indicated by the input. Further, the selected technique may be determined by determining a cost indicator for each candidate technique as applied to the domain interval indicated by the input, and selecting a technique for the domain interval indicated by the input based on the cost indicators.

An example implementation of example embodiments of the present invention may begin with a mathematical function that needs to be calculated for a value of x=x*.

Let y=f(x)

Both the input arguments and the function values may be scalars, vectors, sets of real or complex numbers, or any other types of arguments. The hardware platform where the value of the function is to be calculated may involve N computational elements: CE₁, CE₂, . . . , CE_{N}. Further, there may be K approximation methods: M₁, M₂, . . . , M_{K} for solving/approximating the function. Let C_{i,j}(x)=C(Mᵢ, CEⱼ, x) be a cost function defined for every pair (Mᵢ, CEⱼ) as a function of x, i=1, . . . , K, and j=1, . . . , N. The problem then becomes finding the pair (Mᵢ*, CEⱼ*) to minimize the cost function C_{i,j}(x) for a given value of x=x*:

$$C ( {M}_{i}^{*} , {CE}_{j}^{*} , {x}^{*} ) = {min}_{i = 1 : K , j = 1 : N} ( C ( {M}_{i} , {CE}_{j} , {x}^{*} ) )$$

In practice, it may be easier to evaluate cost function values for intervals (or domains) of input argument values rather than for each value separately. In example embodiments, the value of the cost function may be the same for all argument values belonging to one of the domains for which the cost function value is evaluated. Therefore, the problem may also be reduced to finding optimal pair (Mᵢ*, CEⱼ*) minimizing the cost function C_{i,j}(x) for each value of x from an interval (or a region) X*:

$$C ( {M}_{i}^{*} , {CE}_{j}^{*} , x ) = {min}_{i = 1 : K , j = 1 : N} ( C ( {M}_{i} , {CE}_{j} , x ) ) , ∀ x ∈ {X}^{*}$$

Example embodiments of the present invention may include a method which can be used to compute, in a fast and efficient way, the results of a given mathematical function f(x) and execute the required operations on computational elements available in the target platform that are determined to be optimal for solving the mathematical function with minimal cost. Example methods may exploit a mixtures of calculation/evaluation methods that may be implemented on each computational element of a target platform in order to approximate the desired function within the desired degree of accuracy and at a low computational cost.

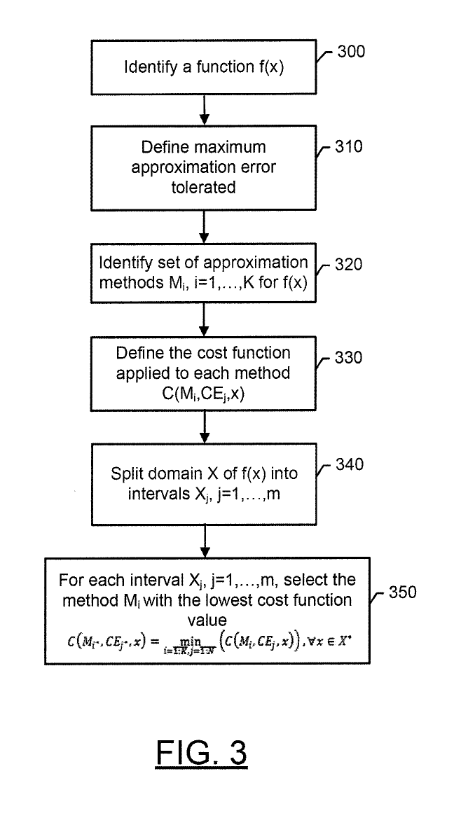

FIG. 3 illustrates an example embodiment of a method according to the present invention. It will be understood that each block or operation of the flowcharts, and/or combinations of blocks or operations in the flowcharts, can be implemented by various means. Means for implementing the blocks or operations of the flowchart, and/or combinations of the blocks or operations in the flowcharts may include hardware, firmware, and/or a computer program product including one or more computer program code instructions, program instructions, or executable computer-readable program code instructions. In one example embodiment, one or more of the procedures described herein may be embodied by program code instructions. In this regard, the program code instructions which embody the procedures described herein may be stored by or on a memory device, such as memory device 110 or 210, of an apparatus, such as apparatus 100 or 200, and executed by a processor, such as the processor 105 or 205. As will be appreciated, any such program code instructions may be loaded onto a computer or other programmable apparatus (e.g., processor 105 or 205, memory device 110 or 210) to produce a machine, such that the instructions which execute on the computer or other programmable apparatus implement the functions specified in the flowcharts' block(s) or operation(s). These program code instructions may also be stored in a computer-readable storage medium that can direct a computer, a processor, or other programmable apparatus to function in a particular manner, such that the instructions stored in the computer-readable storage medium produce an article of manufacture including instruction means which implement the function specified in the flowchart's block(s) or operation(s). The program code instructions may also be loaded onto a computer, processor, or other programmable apparatus to cause a series of operations to be performed on or by the computer, processor, or other programmable apparatus to produce a computer-implemented process such that the instructions which execute on the computer, processor, or other programmable apparatus implement the functions specified in the flowcharts' block(s) or operation(s).

Accordingly, blocks or operations of the flowcharts support combinations of means for performing the specified functions and program code instruction means for performing the specified functions. It will also be understood that one or more blocks or operations of the flowcharts, and combinations of blocks or operations in the flowcharts, can be implemented by special purpose hardware-based computer systems which perform the specified functions or combinations of special purpose hardware and program code instructions.

FIG. 3 depicts a flowchart describing an example method of the present invention. A function f(x) is identified at 300 where x is the input which may consist of one or more variables, that is to be calculated over a certain domain X. The identified function f(x) may not be easily computed using conventional computing systems. For example the function may be trigonometric or transcendental. The maximum allowable approximation error is defined at 310. A set of approximation methods Mᵢ, where i=1, . . . , K for f(x), is identified at 320. Example approximation methods may include CORDIC algorithm, Taylor polynomials, Spline or linear interpolation, Pade approximants, Chebychev, etc.) to approximate f(x) across the domain X. The maximum approximation error may determine, or contribute to the determination of which approximation methods are identified at 320. At 330, computational cost function C_{i,j}=C(Mᵢ, CEⱼ, x) is formulated for each of the approximation methods Mᵢ, i=1, . . . , K, mapped to each of the computational elements CEⱼ, j=1, . . . , N available in the target platform. The cost C_{i,j} could take into account figures such as the quantity of elementary arithmetic operations (addition, multiplication, etc.) or the number of clock cycles required to perform the approximation, power consumption, operating frequency, etc. At 340, the domain of X may be split into domains such that a pair (approximation method and computational element) that corresponds to the lowest average cost for input values from each domain may be identified at 350. Within each interval or domain, a comparison may be drawn as to which of the approximation methods mapped to which of the computational elements guarantees the most convenient implementation (for example, the lowest volume of calculations, the smallest memory requirement, the lowest power consumption, or a combination of these parameters). The most convenient approximation method and computational element for the interval Xₖ may be defined as (Mᵢ*, CEⱼ*) such that C(Mᵢ*, CEⱼ*, x)=min (C(Mᵢ, CEⱼ, x)) for all x belonging to Xₖ. Once the decision regarding which approximation method is mapped on which of the computational elements is the best (most optimized) pair for all the intervals Xₖ, k=1, . . . , m across X, the operations of FIG. 3 are ready to be implemented on a computer system. Each of the aforementioned operations may be performed prior to beginning the actual computation of the function f(x). Upon the calculation beginning, the input x=x* may be analyzed to determine the domain to which it belongs. Then the pair (approximation method, computational element) selected for that domain may be used to calculate the value of f(x*).

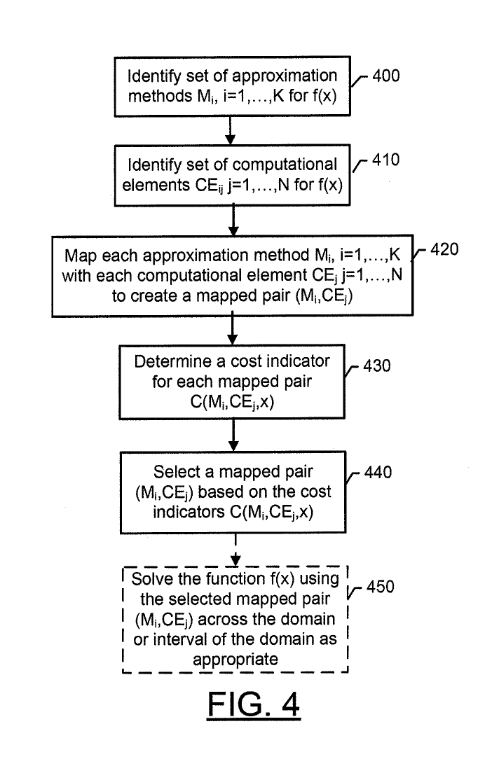

FIG. 4 depicts a flowchart describing another example method of the present invention. A set of approximation methods Mᵢ, where i=1, . . . , K for f(x), is identified at 400. A set of computational elements CEⱼ, where j=1, . . . , N for f(x), is identified at 410. Each approximation method Mᵢ is mapped to each computational element CEⱼ to create a set of mapped pairs (Mᵢ, CEⱼ) at 420. A cost indicator for each mapped pair C(Mᵢ, CEⱼ, x) is determined at 430. A mapped pair (Mᵢ, CEⱼ) is selected at 440 based on the cost indicators C(Mᵢ, CEⱼ, x) for each mapped pair. Optionally, as indicated by the broken lines of element 450, the function may be solved across the domain or domain interval as appropriate.

In an example embodiment, the apparatus for performing the method of FIG. 3 or 4 above may comprise a processor (e.g., the processor 105) configured to perform some or each of the operations (300-350 and/or 400-450) described above. The processor may, for example, be configured to perform the operations (300-350 and/or 400-450) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-350 and/or 400-450 may include, for example, the memory device 110. Additionally or alternatively, at least by virtue of the fact that the processor 105 may be configured to control or even be embodied as the memory device 110, the processor 105 and/or a device or circuitry for executing instructions or executing an algorithm for processing information as described above may also form example means for performing operations 300-350 and/or 400-450.

The goal of the aforementioned example embodiments are to determine the approximation method that guarantees the lowest possible cost and/or that best fits the characteristics of the target platform of the computational elements. The determination of the best approximation method Mᵢ is not bound by the usage of a single, “pure” method, but can be the result from the adoption of a mixture of different approximation techniques in different regions of the domain X where multiple domains are present. Moreover, the same approximation method can be applied to more than one of such intervals, but to a different detail level on each of them. For instance, for x values ranging between 0 and a certain value of xₜ, a “variable precision” Taylor polynomial may be used: the Taylor polynomial is developed to varying degrees of precision on different intervals Xₖ=(x(k−1),xₖ),k=1, . . . , M, of the unknown variable x across the domain X of the function. In example embodiments wherein the function f(x) has several arguments, a series of domains may be defined by defining series of intervals for each of the arguments The precision degree is tuned differently on each interval in order to guarantee that the approximation error remains within a predefined maximum threshold while requiring the minimum possible computational load. Beyond the value xₜ, we may use instead another method (for instance, Spline interpolation or linear interpolation), since they require simpler expressions when compared to high-order Taylor polynomials.

Similarly, an entire approximation method Mᵢ may be executed on a single computational element CEⱼ, or different parts of Mᵢ may be executed concurrently on different computational elements CEⱼ. The mapping of an approximation method M, to a computational element CEⱼ may change over time. For example, parts of Mᵢ that were executing at time t₁ on a given processing element CE₁ might be migrated to another processing element CE₂ at time t₂.

Example embodiments of methods according to the present invention are configured to apply different methods, and variations of those methods, Mᵢ to approximate f(x) and enabling combinations of different such methods to be applied to different intervals of the domain X of f(x). For the computational cost C_{i,j} of each of the methods Mᵢ mapped to each of the computational elements CE_{i,j} within the target platform, C_{i,j} can be used to take into account information such as the volume of elementary arithmetic instructions and memory space necessary to implement Mᵢ on a given computational element CEⱼ. The computational element CEⱼ may be a dedicated hardware circuit, a programmable arithmetic unit on a computer system, or other device as described above. A user may choose the mixture of approximation methods which best suit the characteristics of a desired implementation to guarantee a minimum amount of arithmetic calculations at the expense of larger memory usage or a minimum amount of memory usage at the expense of a higher number of arithmetic calculations.

Upon completion of the methods outlined by the flowcharts of FIGS. 3 and 4, the calculation may be performed according to the determined approximation method and computational element mapped pair (Mᵢ, CEⱼ). The selected computational element executes the approximation method over the domain X of f(x) to arrive at the solution. According to various example embodiments of the present invention, the domain X may be divided into any number of intervals where each interval may have its own mapped pair (Mᵢ, CEⱼ) wherein the mapped pair for each interval is used to solve the function over the interval to which it is assigned. The solution is determined based on all intervals within the domain X and within the accuracy of the maximum error threshold assigned. This operations is shown as optional in FIG. 4 as element 450.

The following provides example implementations of an example embodiment of the method of FIG. 3 for the trigonometric function sinum, hereinafter referred to as sin(x). In this implementation, sin(x) is defined with a domain of negative π to positive π, since sin(x) is a periodic function with a period 2π. The domain may be further restricted to the interval of zero to π/2 since the results for values outside such a range may be easily reproducible. Restrictions of this sort can allow for simpler solutions while also having improved accuracy.

The values for the variable x over the domain of zero to π/2 may be encoded to be 16-bit fixed point values. An approximation method, namely an approximation using the Taylor polynomials, may be identified and cost indicators may be determined. In this example, a desired maximum error resulting in a determination that the polynomial used to approximate sin(x) should be of grade 9. In this regard, the Horner's rule to polynomials may be applied to acquire equivalent and simplified polynomials. Based on the foregoing, the cost indicators may be calculated for this candidate technique.

With respect to an additional candidate technique, a different actuary level of the Taylor polynomial may be used. In this regard, based on the domain interval, it may be determined that valid approximations within the maximum error may be identified with candidate techniques having polynomials of grade 3, 5, 7, and 9. The cost indicators for these approximation methods may be calculated by approximating the function for a given value of the x variable for each approximation method and computational element. The resultant cost indicators may be considered, and based on the cost indicators, an approximation method and computational element pair may be selected for the domain interval, for example, as the least costly pair. The selected pair of approximation methods and computational elements may then be used to configure the computational element of the target platform for use when a solution to the same function is needed.

In accordance with this example, another approximation method that may be considered may be based on the Spline interpolation. The domain of the function may be separated into sixteen intervals and are stored in a look-up table with the corresponding value for sin(x). Calculating the Spline interpolation may then provide a table of coefficients which represent fifteen of the different polynomials having grade 3. Calculation of the maximum error for each domain interval may show an acceptable error across the domain. Again, the Horner's rule may be applied to the polynomials and then the cost indicators may be determined for each of the sixteen domain intervals. Based on the cost indicators, the most appropriate polynomial may be selected for each of the domain intervals.

Subsequently, or potentially simultaneously, the time required to execute the chosen algorithm may be measured for several types of computational elements. For example, it may be possible to execute the function on a variety of processing means such as a software code running on a programmable microprocessor (e.g., Intel® Core Duo, ARM Cortex, TI DSP processors, etc.) and measure how many clock cycles are required before the function is complete. Further, the amount of energy consumed may be evaluated. Optionally, an ASIC circuit may execute the function and the speed and power consumption required may be similarly measured. Upon analyzing the speed and power requirements (cost factors), the function may be mapped, or intervals of the domain may be mapped to the appropriate approximation method and computational element to attain the optimized trade-off between speed and energy consumption while minimizing cost.

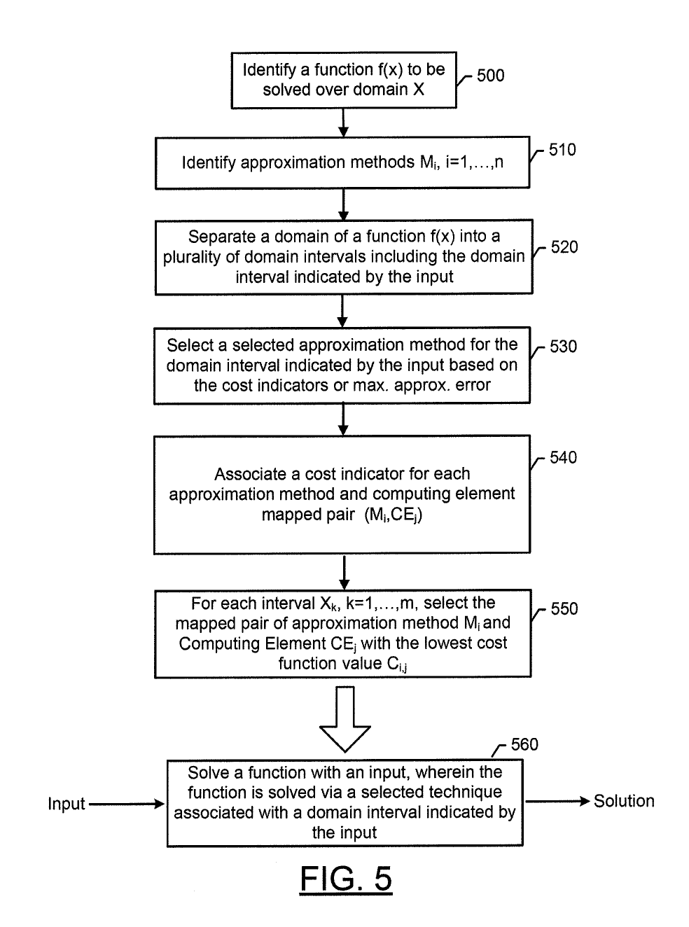

FIG. 5 depicts a flowchart describing an example method of solving a function via a selected technique in accordance with an embodiment of the present invention. The example method may include solving a function with an input at 560. In this regard, the function may be solved via a selected technique associated with a domain interval indicated by the input.

The selected technique for solving the function of 560 may have been selected by identifying the function f(x) at 500, identifying approximation methods Mᵢ at 510, and separating a domain of a function into a plurality of domain intervals including the domain interval indicated by the input at 520. The approximation method for each domain interval may be selected based upon cost indicators or maximum approximation error at 530. A cost factor may be associated with each mapped pair (Mᵢ, CEⱼ) at 540. For example, the selected approximation methods Mᵢ may be executed on different computational elements CEⱼ and a cost factor may be associated with each approximation method and computational element mapped pair (Mᵢ, CEⱼ). For each interval Xₖ, k=1, . . . , m, the mapped pair of approximation method and computational element (Mᵢ, CEⱼ) with the lowest cost function value C_{i,j} may be selected at 550.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
identifying approximation methods for solving a function;
identifying computational elements for solving the function;
mapping each identified approximation method with each identified computational element to create a mapped pair;
determining a cost indicator for each mapped pair;
selecting a mapped pair based on the cost indicators; and
directing the function to be solved using the approximation method and the computational element of the selected mapped pair.

2. The method according to claim 1, wherein the function is to be solved over a domain that comprises at least two domain intervals, wherein identifying approximation methods for solving the function includes identifying approximation methods for solving the function over each of the at least two domain intervals, and wherein identifying computational elements for solving the function includes identifying computational elements for solving the function over each of the at least two domain intervals.

3. The method according to claim 2, wherein selecting a mapped pair based on the cost indicators comprises selecting a mapped pair for each of the at least two domain intervals based on the cost indicators of each mapped pair and wherein directing the function to be solved comprises directing the function to be solved over each of the at least two domain intervals using the approximation method and the computational element of the selected mapped pair for each respective domain interval.

4. The method according to claim 3, wherein directing the function to be solved over each of the at least two domain intervals comprises identifying the domain interval to which a current input to the function belongs and directing the function to be solved for the current input using the approximation method and the computational element of the selected mapped pair for the identified domain interval.

5. The method according to claim 3, wherein the selected mapped pairs for each of at least two domain intervals comprises the same approximation method but having different accuracy levels, the accuracy levels being associated with approximation methods employing approximations using polynomials of different orders.

6. The method according to claim 1, wherein identifying approximation methods for solving the function includes identifying approximation methods for solving the function based on a maximum error threshold.

7. The method according to claim 1, wherein determining the cost indicator for each mapped pair includes determining the cost indicator based on a number of arithmetic computations needed for solving the function using the approximation method of the mapped pair.

8. An apparatus comprising a processor and at least one memory including computer program code, the at least one memory and the computer program code configured to, with the at least one processor, cause the apparatus to perform:
identify approximation methods for solving a function;
identify computational elements for solving the function;
map each identified approximation method with each identified computational element to create a mapped pair;
determine a cost indicator for each mapped pair;
select a mapped pair based on the cost indicators; and
direct the function to be solved using the approximation method and the computational element of the selected mapped pair.

9. The apparatus according to claim 8, wherein the function is to be solved over a domain that comprises at least two domain intervals, wherein the apparatus is caused to identify approximation methods for solving the function by identifying approximation methods for solving the function over each of the at least two domain intervals, and wherein the apparatus is caused to identify computational elements for solving the function by identifying computational elements for solving the function over each of the at least two domain intervals.

10. The apparatus according to claim 9, wherein causing the apparatus to select a mapped pair based on the cost indicators comprises causing the apparatus to select a mapped pair for each of the at least two domain intervals based on the cost indicators of each mapped pair and wherein causing the apparatus to direct the function to be solved comprises causing the apparatus to direct the function to be solved over each of the at least two domain intervals using the approximation method and the computational element of the selected mapped pair for each respective domain interval.

11. The apparatus according to claim 10, wherein causing the apparatus to direct the function to be solved over each of the at least two domain intervals comprises causing the apparatus to identify the domain interval to which a current input to the function belongs and causing the apparatus to direct the function to be solved for the current input using the approximation method and the computational element of the selected mapped pair for the identified domain interval.

12. The apparatus according to claim 11, wherein the selected mapped pairs for each of the at least two domain intervals comprise the same approximation method but having different accuracy levels, the accuracy levels being associated with approximation methods employing approximations using polynomials of different orders.

13. The apparatus according to claim 8, wherein causing the apparatus to identify approximation methods for solving the function includes causing the apparatus to identify approximation methods for solving the function based on a maximum error threshold.

14. The apparatus according to claim 8, wherein causing the apparatus to determine the cost indicator for each mapped pair includes causing the apparatus to determine the cost indicator based on a number of arithmetic computations needed for solving the function using the approximation method of the mapped pair.

15. A computer program product comprising at least one computer-readable storage medium having computer-executable program code instructions stored therein, the computer-executable program code instructions comprising:
program code instructions for identifying approximation methods for solving a function;
program code instructions for identifying computational elements for solving the function;
program code instructions for mapping each identified approximation method with each identified computational element to create a mapped pair;
program code instructions for determining a cost indicator for each mapped pair;
program code instructions for selecting a mapped pair based on the cost indicators; and
program code instructions for directing the function to be solved using the approximation method and the computational element of the selected mapped pair.

16. The computer program product according to claim 15, wherein the function is to be solved over a domain that comprises at least two domain intervals, wherein the program code instructions for identifying approximation methods for solving the function include program code instructions for identifying approximation methods for solving the function over each of the at least two domain intervals, and wherein the program code instructions for identifying computational elements for solving the function comprise program code instructions for identifying computational elements for solving the function over each of the at least two domain intervals.

17. The computer program product according to claim 16, wherein the program code instructions for selecting a mapped pair based on the cost indicators comprise program code instructions for selecting a mapped pair for each of the at least two domain intervals based on the cost indicators of each mapped pair and wherein the program code instructions for directing the function to be solved comprises program code instructions for directing the function to be solved over each of the at least two domain intervals using the approximation method and the computational element of the selected mapped pair for each respective domain interval.

18. The computer program product according to claim 17, wherein the program code instructions for directing the function to be solved over each of the at least two domain intervals comprises program code instructions for identifying the domain interval to which a current input to the function belongs and program code instructions for directing the function to be solved for the current input using the approximation method and the computational element of the selected mapped pair for the identified domain interval.

19. The computer program product according to claim 17, wherein the selected mapped pairs for each of at least two domain intervals comprise the same approximation method but having different accuracy levels, the accuracy levels being associated with approximation methods employing approximations using polynomials of different orders.

20. The computer program product according to claim 15, wherein the program code instructions for identifying approximation methods for solving the function include program code instructions for identifying approximation methods for solving the function based on a maximum error threshold.
